(19) United States
(12) Patent Application Publication
(10) Pub. No.: US 2013/0300538 A1
(43) Pub. Date: Nov. 14, 2013

(54) RFID TAG READER AND METHOD FOR READING AN RFID TAG

(71) Applicant: Dirk A. BROER, Silver Spring, MD (US)

(72) Inventor: Dirk A. BROER, Silver Spring, MD (US)

(73) Assignee: MOTOROLA SOLUTIONS, INC., Schaumburg, IL (US)

(21) Appl. No.: 13/466,222

(22) Filed: May 8, 2012

(51) Int. Cl. G06K 7/01

(52) U.S. Cl. 340/10.1

(57) ABSTRACT

An RFID reader and method for reading an RFID tag is provided herein. The RFID reader operates in a “bistatic” mode, utilizing two RF antennas, one for transmitting an RF signal, and one for receiving an RF signal. The transmit and receive antennas do not “point” in a same direction resulting in lobe patterns that will intersect at an angle.

### FIELD OF THE INVENTION

The present invention generally relates to radio-frequency identification (RFID) tag readers, and more particularly to an RFID tag reader and method for reading an RFID tag.

### BACKGROUND OF THE INVENTION

Retailers considering the use of radio-frequency identification (RFID) need a way to read RFID tags at a “point of sale” to the exclusion of all other RFID tags in the area. Typically retail stores have merchandise near checkout to capture the last second impulse buy and if these items have RFID tags they could be erroneously read. A similar situation exists with kiosks that are designed to interact with RFID tags and portals that need to exclude nearby RFID tags. Therefore a need exists for an RFID tag reader and method for reading an RFID tag that better reads tags at a point of sale to the exclusion of all other RFID tags.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is a block diagram of a RFID system.

FIG. 2 is a block diagram of a RFID reader.

FIG. 3 is a block diagram of a RFID tag.

FIG. 4 illustrates a transmit antenna and a receive antenna.

FIG. 5 illustrates an RFID reader's capabilities for reading RFID tags.

FIG. 6 is a flow chart showing operation of the RFID reader of FIG. 4 and FIG. 5.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required.

### DETAILED DESCRIPTION

In order to address the above-mentioned need an RFID reader and method for reading an RFID tag is provided herein. An RFID reader and method for reading an RFID tag is provided herein. The RFID reader operates in a “bistatic” mode, utilizing two RF antennas, one for transmitting an RF signal, and one for receiving an RF signal. The transmit and receive antennas do not “point” in a same direction resulting in lobe patterns that will intersect at an angle.

Bistatic operation refers to a mode of operation where a separate transmit and a separate receive antenna are utilized within a device. Among other things, operating in a bistatic mode helps isolate the high powered transmission signal from RFIDs significantly weaker signal from tags (the received signal). Antenna lobe patterns are an indication of the directionality of the antenna and the signal strength in that direction. The intersections of each antenna lobe creates an area of relatively higher sensitivity to RFID tags than areas outside this intersection. The end result is that tags outside of this confined area show a significantly reduces Return Signal Strength Indicator (RSSI) and can easily be filtered away.

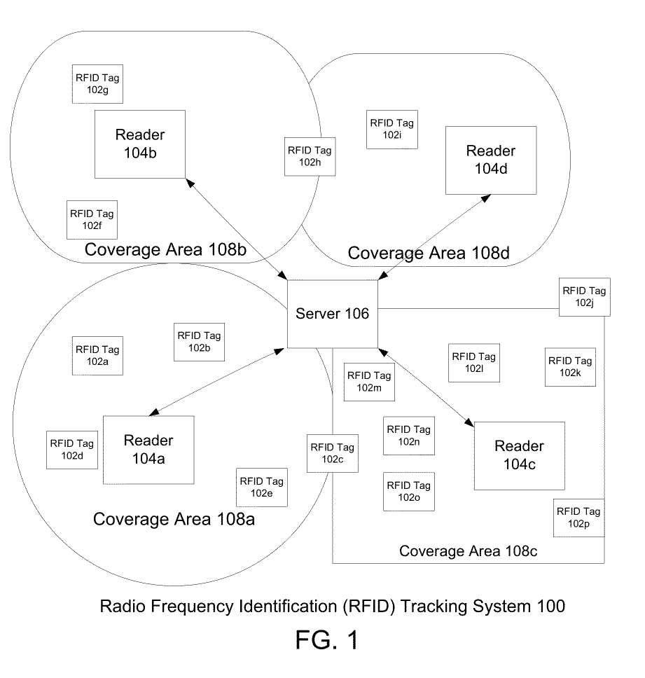

FIG. 1 is a block diagram of a RFID system. The RFID system 100 includes at least one RFID reader 104 (also referred to herein as a reader 104), each of which is configured to send and receive radio frequency (RF) signals within a coverage area 108. The readers 104 may operate independently or may be coupled together to form a reader network. Additionally, the readers 104 may comprise handheld, mobile readers.

Each reader 104 is also configured to communicate with one or more RFID tags 102 (also referred to herein as a tag 102), within its predefined coverage area. The RFID tags 102 can be affixed or attached to one or more items. Each reader 104 may interrogate the tags 102 within its coverage area 108 by transmitting an interrogation signal. The tags 102 within the reader's coverage area may transmit one or more response signals to the reader in a variety of ways, including by alternatively reflecting and absorbing portions of the interrogation signal according to a time-based pattern or frequency.

Each RFID tag 102 may convey information about an individual item or type of item to which the tag is attached or affixed. For example, a RFID tag 102 may be affixed or attached to an item for sale. The RFID tag 102 can therefore provide information sufficient for determining, for example, a price of the item for sale. After receiving a response signal from the tag 102, the reader 104 may transmit data obtained from the tag 102 to a server 106 for inventory control, and/or to a cash register (not shown) for checkout purposes.

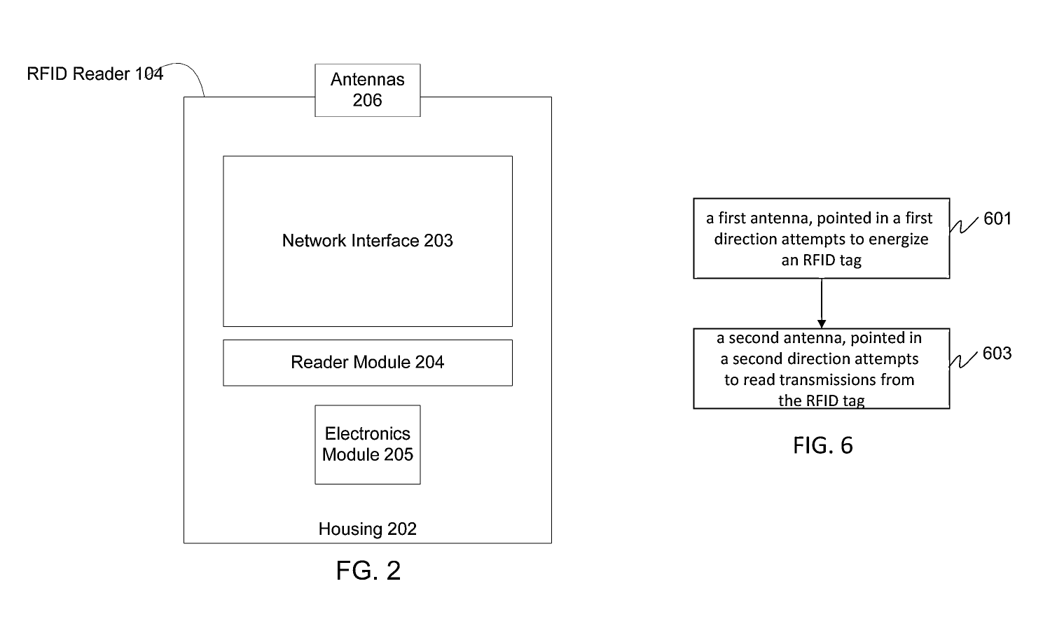

FIG. 2 is a block diagram of an RFID reader. The RFID reader 104 generally includes a housing 202, a network interface 203 contained within the housing 202, an RFID reader module 204 contained within the housing 202, an electronics module 205 contained within the housing 202, and at least two RFID antennas 206 (which can be, but are not necessarily, contained within the housing 202). The network interface 203 may be configured to communicate with one or more wireless or wired network devices, or a cash register. In some embodiments, the electronics module 205 can be physically realized as an integrated component, board, card, or package mounted within the housing 202. The electronics module 205 may include one or more memory portions for storing instructions, wherein one or more of the memory portions are coupled to one or more processors for performing functions associated with the RFID reader 104. The RFID reader module 204 can be coupled to the RFID antennas 206 using suitable techniques. For example, the reader module 204 and the RFID antennas 206 can be connected via an RF cable and RF connector assemblies. The RFID reader module 204 is configured to send RF signals to and receive RF signals from a tag in the reader's coverage area. The RFID reader module 204 operates in a bistatic mode, utilizing a first antenna exclusively for transmitting, and a second antenna exclusively for receiving.

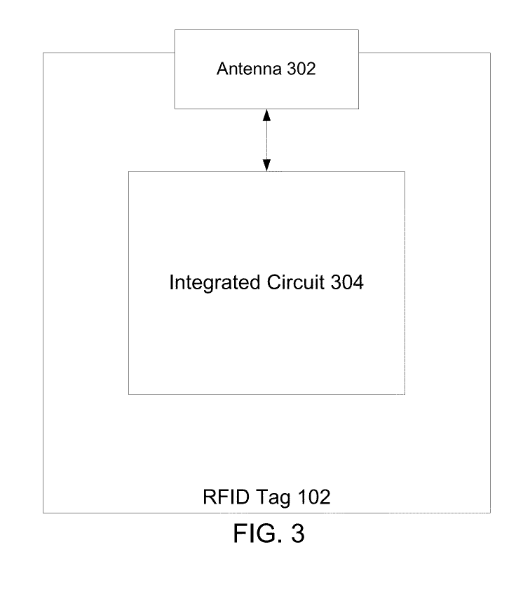

FIG. 3 is a block diagram of a RFID tag used in accordance with some embodiments. The RFID tag 102 includes an antenna 302 and an integrated circuit 304. The antenna 302 is configured to receive and transmit RF signals. The integrated circuit 304 is configured to store and process information. The RFID tag 102 can be positioned within transmission range of the RFID reader 104. Accordingly, the RFID tag 102 can receive an interrogation signal sent from the RFID reader 104 with the antenna 302. The integrated circuit 304 can perform one or more operations in response to receiving the interrogation signal, including modulating the interrogation signal. The integrated circuit 304 can have additional functions such as inputs from sensors or other circuits. After processing the interrogation signal, the RFID tag 102 can transmit a response signal to the RFID reader 104 through the antenna 302. Upon receipt of the response signal, the RFID reader 104 may extract information from the response signal and transmit the extracted information to the server 106. Information from the RFID tag may include identity information, pricing information, or information regarding the state of sensors or circuits coupled to the RFID tag.

In general, a RFID tag 102 can be classified as an active tag or a passive tag, or a combination thereof, depending on how the signal is induced in the RFID tag. An active tag includes an internal power source to continuously power its RF communication circuitry. A passive tag, on the other hand, does not have an internal power source but relies on external sources to stimulate signal transmission. For example, a passive tag may obtain the power required to simulate signal transmission from interrogation signals sent from the reader's transmit antenna. An active tag is typically larger and more expensive than a passive tag at least because of the added power source in the active tag.

As discussed above, retailers considering the use of radio-frequency identification (RFID) need a way to read RFID tags at a “point of sale” to the exclusion of all other RFID tags in the area. Typically retail stores have merchandise near checkout to capture the last second impulse buy and if these items have RFID tags they could be erroneously read. A similar situation exists with kiosks that are designed to interact with RFID tags and portals that need to exclude nearby RFID tags. In order to address this issue, RFID reader 104 operates in a “bistatic” mode, utilizing two RF antennas, one for transmitting an RF signal, and one for receiving an RF signal. Instead of making the transmit and receive antenna lobe patterns parallel, the lobe patterns will intersect at an angle. The intersections of each antenna lobe creates an area of relatively higher sensitivity to RFID tags than areas outside this intersection. The end result is that tags outside of this confined area (intersection of each antenna lobe pattern) show a significantly reduces RSSI and can easily be filtered away.

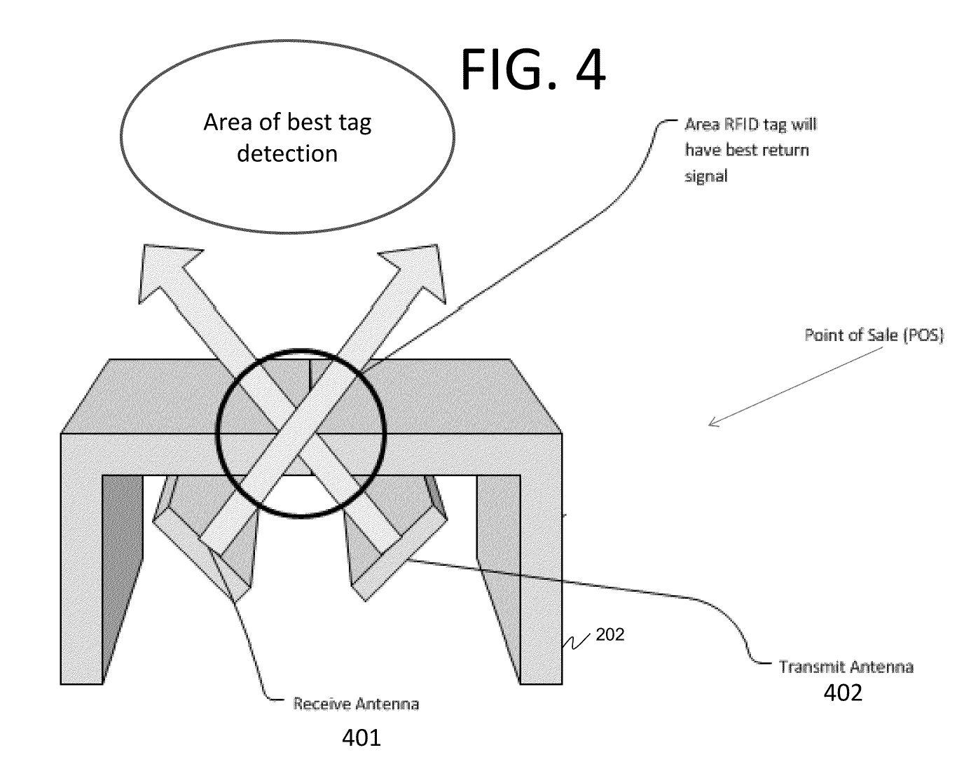

FIG. 4 is a block diagram of RFID reader 104. As shown, receive antenna 401 and transmit antenna 402 exist within housing 202, however, as mentioned above, these antennas may exist external to housing 202. As shown, receive antenna 401 and transmit antenna 401 point in different directions. Antennas 401 and 402 may or may not be perpendicular to each other. With this configuration an area of best tag detection exists between the intersection of antennas 401 and 402.

Thus, as shown, reader 104 comprises a transmit antenna transmitting and pointing in a first direction, and used to energize an RFID tag. A receive antenna is provided pointing in a second direction, and used to read transmissions (or RF reflecting) from the energized RFID tag. The first direction and the second direction may be orthogonal to each other. An RFID tag reflects power from the transmit antenna to the receive antenna. The transmit antenna is used exclusively to transmit signals, and the receive antenna is used exclusively to receive signals. As discussed above, the RFID reader may comprise a mobile, handheld RFID reader. Finally, preferably the transmit antenna and the receive antenna have an angle between them that is unchanging over time.

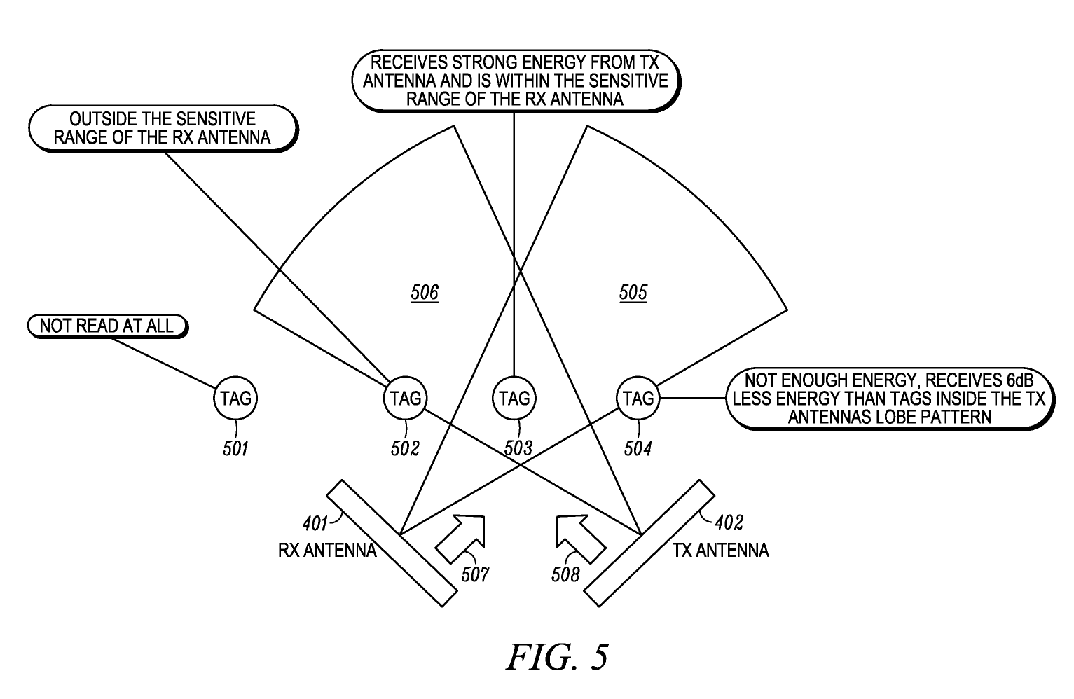

It should be noted that the area of best tag detection is offset from each antenna's lobe pattern. For example, receive antenna 401 is pointed in a first direction, and has a highest receive sensitivity along the first direction. In a similar manner, transmit antenna 402 is pointed in a second direction, and has a highest transmit energy along the second direction. The first direction and the second direction are offset from each other. Thus tags are energized by a transmit antenna pointing in the second direction, and are read via an antenna pointing in a first direction. This is explained in greater detail in FIG. 5.

FIG. 5 illustrates receive antenna 401 pointed in a first direction 507 and transmit antenna 402 pointed in a second direction 508. Receive antenna 401 will have an area of greatest sensitivity 506 radiating in the first direction 507. In a similar manner, transmit antenna 402 will direct the greatest amount of transmit energy in area 506 along the second direction 508. In this particular embodiment RFID tags 501-504 operate as passive RFID tags. In other words, as is known in the art, each RFID tag 501-504 reflects and modulates the initiator-provided electromagnetic field, thus making each RFID tag 501-504 a transponder. The initiator-provided electromagnetic field is generated from transmit antenna 402 along direction 508.

Consider RFID tag 501. Since this tag is neither within an area of greatest sensitivity for either antenna 401 or antenna 402, it will not be energized by antenna 402, nor read by antenna 401. Now, consider tag 502. Since this tag is somewhat near area 506 the tag will be energized by transmit antenna 402, however it is nowhere near area 505, thus will not be read when tag 502 transmits. Since tag 503 is within both area 505 and 506, it will be energized and read by reader 104. Finally, consider tag 504, since this tag is nowhere near area 506, it will not be energized, thus, even though it is near area 505 it will not be read.

FIG. 6 is a flow chart showing operation of an RFID reader. The logic flow begins at step 601 where a first antenna, pointed in a first direction attempts to energize an RFID tag. At step 602, a second antenna, pointed in a second direction attempts to read transmissions from the RFID tag. As discussed above, the first antenna and the second antennas are preferably, but not necessarily orthogonal to each other. Additionally, the RFID tag reflects and modulates an electromagnetic field radiated by the first antenna to the second antenna.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

Those skilled in the art will further recognize that references to specific implementation embodiments such as “circuitry” may equally be accomplished via either on general purpose computing apparatus (e.g., CPU) or specialized processing apparatus (e.g., DSP) executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. An RFID reader comprising:
a transmit antenna transmitting and pointing in a first direction, and used to energize an RFID tag;
a receive antenna pointing in a second direction, and used to read transmissions from the energized RFID tag.

2. The reader of claim 1 wherein the first direction and the second direction are orthogonal to each other.

3. The reader of claim 1 wherein the RFID tag reflects power from the transmit antenna to the receive antenna.

4. The reader of claim 1 wherein the transmit antenna is used exclusively to transmit signals, and the receive antenna is used exclusively to receive signals.

5. The reader of claim 1 wherein the transmit antenna and the receive antenna are within a same housing.

6. The reader of claim 1 wherein the RFID reader is a handheld RFID reader.

7. The reader of claim 1 wherein the transmit antenna and the receive antenna have an angle between them that is unchanging over time.

8. A method for operating an RFID reader, the method comprising the steps of:
the RFID reader using a transmit antenna transmitting and pointing in a first direction, and used to energize an RFID tag;
the RFID reader using an antenna pointing in a second direction to read transmissions from the energized RFID tag.

9. The method of claim 8 wherein the first direction and the second direction are orthogonal to each other.

10. The method of claim 8 wherein the RFID tag reflects power from the transmit antenna to the receive antenna.

11. The method of claim 8 wherein the transmit antenna is used exclusively to transmit signals, and the receive antenna is used exclusively to receive signals.

12. The method of claim 8 wherein the transmit antenna and the receive antenna are within a same housing.

13. The method of claim 8 wherein the RFID reader is a handheld RFID reader.

14. The method of claim 8 wherein the transmit antenna and the receive antenna have an angle between them that is unchanging over time.

15. An RFID reader comprising:
a transmit antenna transmitting and pointing in a first direction, and used to energize an RFID tag;
a receive antenna pointing in a second direction, and used to read transmissions from the energized RFID tag;
wherein the RFID tag reflects power from the transmit antenna to the receive antenna;
wherein the transmit antenna is used exclusively to transmit signals, and the receive antenna is used exclusively to receive signals;
wherein the transmit antenna and the receive antenna are within a same housing;
wherein the RFID reader is a handheld RFID reader; and
wherein the transmit antenna and the receive antenna have an angle between them that is unchanging over time;
